(19) United States
(12) Patent Application Publication
(10) Pub. No.: US 2021/0357086 A1
(43) Pub. Date: Nov. 18, 2021

(54) AGENT CONTROL DEVICE, AGENT CONTROL METHOD, AND RECORDING MEDIUM

(71) Applicant: TOYOTA JIDOSHA KABUSHIKI KAISHA, Toyota-shi (JP)

(72) Inventor: Kohki TAKESHITA, Tokyo (JP)

(73) Assignee: TOYOTA JIDOSHA KABUSHIKI KAISHA, Toyota-shi (JP)

(21) Appl. No.: 17/244,374

(22) Filed: Apr. 29, 2021

(30) Foreign Application Priority Data
May 18, 2020 (JP) 2020-086991

(51) Int. Cl. G06F 3/0482; G06F 3/0488

(52) U.S. Cl. CPC G06F 3/0482; G06F 3/04883

(57) ABSTRACT

An agent control device that acquires identification information for a plurality of agents utilizable inside a vehicle; and controls a display device so as to display a list of selection information for the plurality of agents according to the acquired identification information for the plurality of agents, and performs control to activate an agent corresponding to selection information selected by a user.

### CROSS-REFERENCE TO RELATED APPLICATION

This application is based on and claims priority under 35 USC 119 from Japanese Patent Application No. 2020-086991 filed on May 18, 2020, the disclosure of which is incorporated by reference herein.

### BACKGROUND

### Technical Field

The present disclosure relates to an agent control device, an agent control method, and a recording medium.

### Related Art

Technology for controlling operation of two agents is known. One example of such known technology is a speech interaction method for utilizing services provided by two agents in which agent information such as a keyword used to identify an agent is employed to decide which out of the two agents should respond (see, for example, Japanese Patent Application Laid-Open (JP-A) No. 2018-189984).

The agents disclosed in JP-A No. 2018-189984 may, for example, be utilizable inside a vehicle. When an agent is utilized inside a vehicle, the agent performs speech interaction with a user, and executes processing that reflects the content of this interaction. The agent then uses equipment inside the vehicle to output an execution result of this processing so as to reflect the interaction content.

In the technology disclosed in JP-A No. 2018-189984, the agent to respond is decided based on a keyword or the like identifying the agent. However, in the technology disclosed in JP-A No. 2018-189984, the user needs to utter the keyword or the like in order to identify the agent, and so there is room for improvement regarding smooth selection of an agent.

For example, plural utilizable agents may be available inside a vehicle. However, the technology disclosed in JP-A No. 2018-189984 only discloses selection of a target agent based on a keyword identifying the agent, and does not consider situations in which plural utilizable agents are available inside the vehicle.

Thus, with the technology disclosed in JP-A No. 2018-189984 an issue may arise in which agent selection cannot be smoothly performed during user selection of a utilizable agent when on board a vehicle.

### SUMMARY

An aspect of the disclosure is an agent control device that includes: a memory; and a processor coupled to the memory. The processor is configured to acquire identification information for a plurality of agents utilizable inside a vehicle, and perform control so as to display, on a display device, a list of selection information for the plurality of agents according to the acquired identification information for the plurality of agents, and activate an agent corresponding to selection information selected by a user inside the vehicle.

### BRIEF DESCRIPTION OF THE DRAWINGS

Exemplary embodiments of the present disclosure will be described in detail based on the following figures, wherein:

FIG. 1 is an explanatory diagram to provide schematic explanation of an exemplary embodiment;

FIG. 2 is a schematic block diagram illustrating an example of an agent control system according to an exemplary embodiment;

FIG. 3 is a diagram illustrating an example of configuration of a computer of an agent control device;

FIG. 4 is a diagram illustrating an example of identification information for plural agents;

FIG. 5 is a flowchart illustrating an example of processing performed by an agent control device according to an exemplary embodiment;

FIG. 6 is a diagram illustrating an example of a screen displayed on a touch panel; and

FIG. 7 is a diagram illustrating an example of a screen displayed on a touch panel.

### DETAILED DESCRIPTION

### Exemplary Embodiment

Explanation follows regarding an agent control system of an exemplary embodiment, with reference to the drawings.

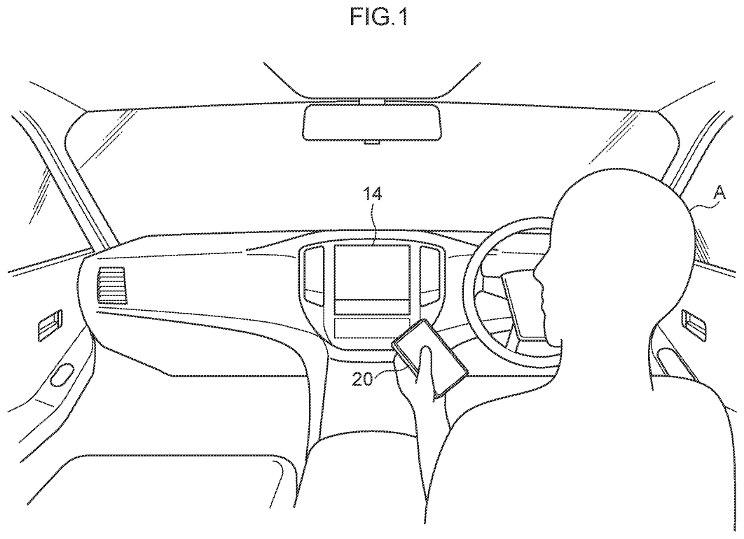

FIG. 1 is an explanatory diagram to provide schematic explanation of the present exemplary embodiment. FIG. 1 is a diagram illustrating a situation in which a user A is on board a vehicle. The user A possesses a mobile terminal 20 such as a smartphone. FIG. 1 also illustrates a touch panel 14, this being an example of a display device that displays various information, located inside the vehicle. The touch panel 14 and the mobile terminal 20 are connected to an agent control device, described later. The display device is not limited to a touch panel. The display device can be any presenter that can present or display various information.

In the present exemplary embodiment, the user A utilizes an agent capable of performing speech interaction inside the vehicle. An agent of the present exemplary embodiment performs speech interaction with the user A, and executes processing that reflects the content of this interaction. The agent then uses equipment inside the vehicle to output an execution result of this processing so as to reflect the interaction content. The agents of the present exemplary embodiment are implemented by agent servers, described later, executing predetermined programs.

Plural agents may be utilizable by the user A inside the vehicle. For example, in such cases the user A may wish to utilize an agent that they regularly utilize on their mobile terminal 20 when inside the vehicle. Alternatively, the user A may wish to utilize an agent that they use at home when inside the vehicle. Alternatively, the user A may wish to utilize an agent that can only be utilized inside the vehicle when inside the vehicle.

In cases in which plural utilizable agents are available inside the vehicle, the agent control device of the present exemplary embodiment displays a list of the plural agents on the touch panel 14. The user A then selects a target agent to utilize from out of the plural agents. This enables smooth agent selection by the user A in cases in which plural utilizable agents are available inside the vehicle. The user A is thus capable of utilizing a desired agent inside the vehicle.

Detailed explanation thereof follows below.

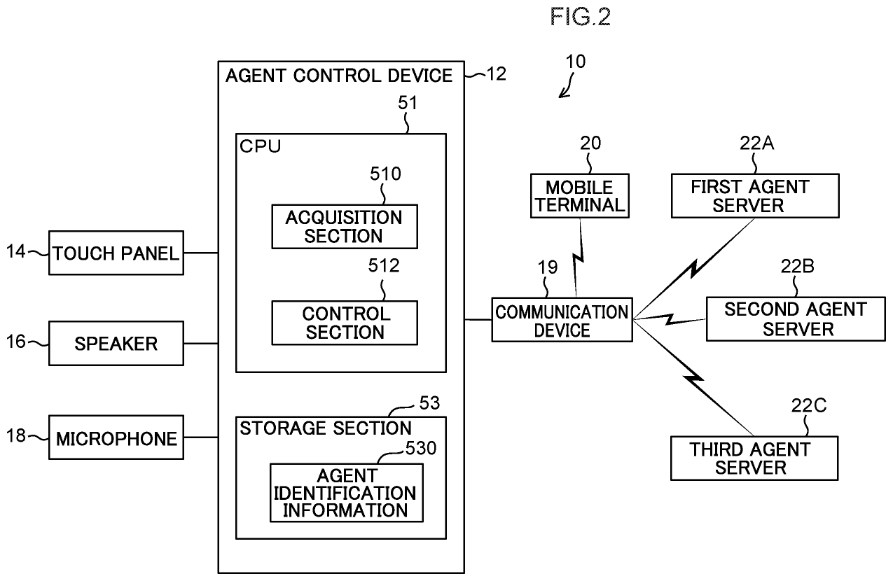

FIG. 2 is a block diagram illustrating an example of configuration of an agent control system 10 according to the exemplary embodiment. As illustrated in FIG. 2, the agent control system 10 includes an agent control device 12, the touch panel 14, a speaker 16, a microphone 18, a communication device 19, the mobile terminal 20, a first agent server 22A, a second agent server 22B, and a third agent server 22C. The agent control device 12, the touch panel 14, the speaker 16, the microphone 18, and the communication device 19 are all installed in a single vehicle.

Agent Control Device

As illustrated in FIG. 2, the agent control device 12 includes a central processing unit (CPU) 51 and a storage section 53.

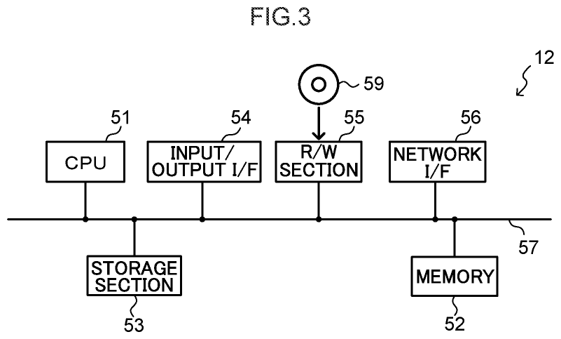

More specifically, the agent control device 12 may for example be implemented by a computer such as that illustrated in FIG. 3. The computer that implements the agent control device 12 includes the CPU 51, this being an example of a hardware processor, memory 52 serving as a temporary storage region, and the non-volatile storage section 53. The computer also includes an input/output interface (I/F) 54 to which an input/output device and so on are connected, and a read/write (R/W) section 55 that controls reading and writing of data on a recording medium 59. The computer also includes a network I/F 56 that is connected to a network such as the internet. The CPU 51, the memory 52, the storage section 53, the input/output I/F 54, the R/W section 55, and the network I/F 56 are connected to each other through a bus 57.

The storage section 53 may be implemented by a hard disk drive (HDD), a solid state drive (SSD), flash memory, or the like, these being examples of a non-transitory recording medium. The storage section 53 serves as a storage medium stored with a program causing the computer to implement functionality. The CPU 51 reads the program from the storage section 53, expands the program in the memory 52, and sequentially executes processes included in the program. The program may for example be recorded on a non-transitory recording medium such as a digital versatile disc (DVD), and read into the HDD, SSD, or the like from this non-transitory recording medium using a recording medium reader device.

As illustrated in FIG. 2, the CPU 51 of the agent control device 12 loads the program from the storage section 53 and executes the program using the memory 52 as a workspace in order to function as an acquisition section 510 and a control section 512. Processing performed by the acquisition section 510 and the control section 512 is described later.

As is also illustrated in FIG. 2, agent identification information 530 is stored in the storage section 53 of the agent control device 12.

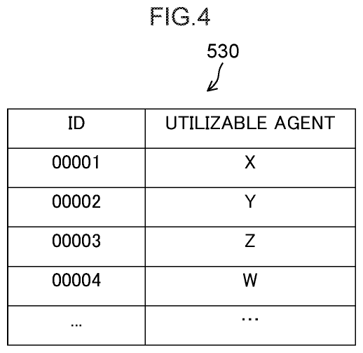

FIG. 4 is a diagram illustrating an example of the agent identification information 530 stored in the storage section 53. FIG. 4 illustrates an example of identification information for an agent X operated by the first agent server 22A, an agent Y operated by the second agent server 22B, an agent Z operated by the third agent server 22C, and an agent W operated by the mobile terminal 20. Note that the agent identification information 530 may be acquired by the acquisition section 510 and retained by the storage section 53 whenever agent activation processing, described later, is executed.

The touch panel 14 is connected to the agent control device 12 through the input/output I/F 54. The touch panel 14 displays images as appropriate. The touch panel 14 also receives operation information from a user.

The speaker 16 is connected to the agent control device 12 through the input/output I/F 54, and outputs audio.

The microphone 18 is connected to the agent control device 12 through the input/output I/F 54, and picks up speech uttered inside the vehicle.

The communication device 19 is connected to the agent control device 12 through the network I/F 56. The agent control device 12 exchanges information with the first agent server 22A, the second agent server 22B, and the third agent server 22C via the communication device 19. Note that the communication device 19 and the first agent server 22A, the second agent server 22B, and the third agent server 22C may for example be connected together over a communication line such as the internet.

Similarly, the agent control device 12 and the mobile terminal 20 exchange information via the communication device 19. The agent control device 12 and the mobile terminal 20 are for example connected together using a predetermined short range communication protocol.

Agent Servers

As illustrated in FIG. 2, the agent control system 10 of the present exemplary embodiment includes the first agent server 22A, the second agent server 22B, and the third agent server 22C.

The first agent server 22A, the second agent server 22B, and the third agent server 22C are all servers that operate agents. The respective agents are implemented by the first agent server 22A, the second agent server 22B, and the third agent server 22C each executing a predetermined program. In the present exemplary embodiment, the agent X is operated by the first agent server 22A, the agent Y is operated by the second agent server 22B, and the agent Z is operated by the third agent server 22C.

Mobile Terminal

The mobile terminal 20 is for example a smartphone in the possession of and regularly used by a user inside the vehicle. The user on board the vehicle is able to utilize an agent operated by the mobile terminal 20. Note that the agent W is operated by the mobile terminal 20 in the present exemplary embodiment.

Next, explanation follows regarding operation of the agent control system 10 of the exemplary embodiment.

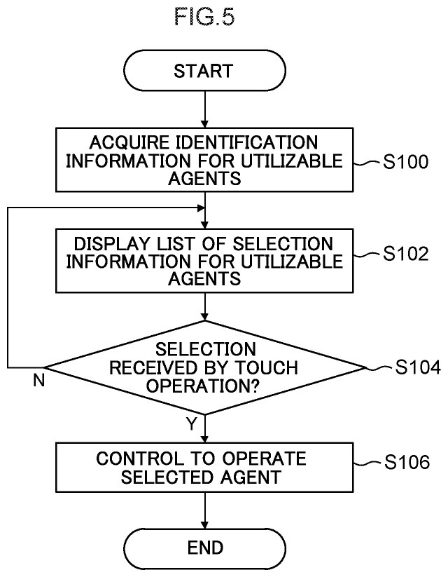

On receipt of a signal indicating that the user will utilize an agent inside the vehicle, the agent control device 12 executes the agent control processing routine illustrated in FIG. 5.

At step S100, the acquisition section 510 of the CPU 51 of the agent control device 12 acquires the agent identification information 530 of the plural utilizable agents available inside the vehicle. The acquisition section 510 then temporarily retains the identification information 530 of the plural agents in the storage section 53.

For example, as illustrated in FIG. 4, at step S100 the acquisition section 510 acquires the identification information 530 for the agent X operated by the first agent server 22A, the agent Y operated by the second agent server 22B, the agent Z operated by the third agent server 22C, and the agent W operated by the mobile terminal 20, and temporarily retains this agent identification information 530 in the storage section 53.

At step S102, the control section 512 of the CPU 51 of the agent control device 12 reads the identification information 530 that was retained in the storage section 53 at step S100. The control section 512 then performs control so as to display a list S of selection information for the plural agents according to the identification information 530 on the touch panel 14.

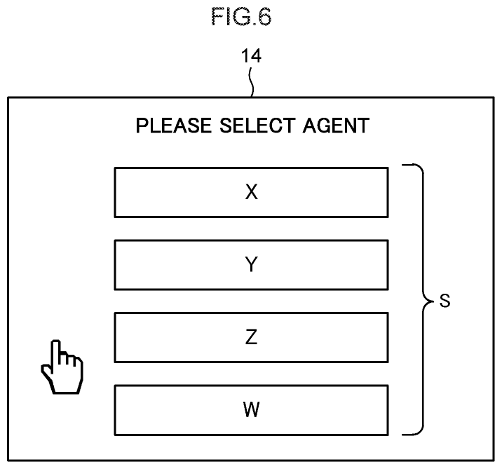

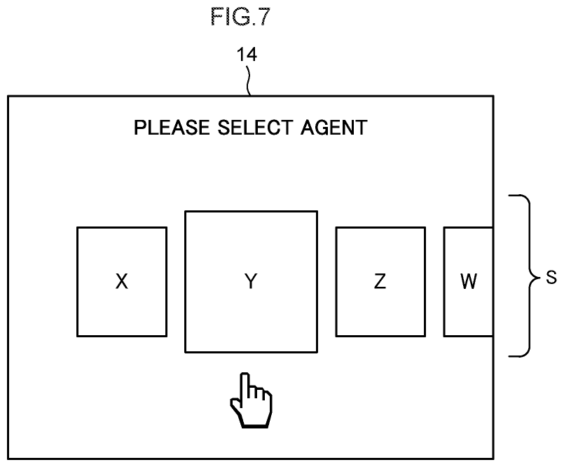

For example, the control section 512 displays a list S of the selection information for the plural agents such as that illustrated in FIG. 6 on the touch panel 14. Note that as illustrated in FIG. 7, the control section 512 may display the list S of the selection information for the plural agents in a swipeable format. The user swipes the screen of the touch panel 14 in a sideways direction in order to enlarge the selection information displayed for a specific agent relative to the selection information for the other agents.

At step S104, the control section 512 determines whether or not a user touch operation has been performed to select an agent from the list S of the selection information displayed on the touch panel 14 at step S102. In cases in which a user touch operation to select an agent has been received due to the user making a selection from the selection information included in the list S, processing proceeds to step S106. On the other hand, in cases in which a user touch operation not been received and an agent is yet to be selected, processing returns to step S102.

At step S106, the control section 512 performs control to activate the agent corresponding to the selection information selected by the user at step S104.

For example, in a case in which the agent X has been selected by the user, the control section 512 uses the communication device 19 to transmit a control signal to instruct operation of the agent X corresponding to the first agent server 22A to the first agent server 22A. The agent X corresponding to the first agent server 22A is thus operated, and an interaction between the user and the agent X inside the vehicle using the speaker 16 and the microphone 18 begins.

As described above, the agent control device 12 of the agent control system 10 according to the present exemplary embodiment acquires the identification information of the plural utilizable agents available inside the vehicle and performs control to display on the display device the selection information for the plural agents according to the acquired identification information of the plural agents. The agent control device 12 then performs control to activate an agent corresponding to selection information selected by the user inside the vehicle. This enables smooth selection of an agent by the user in cases in which the user selects a utilizable agent when the user is on board the vehicle.

Although explanation has been given in which the processing performed by the respective devices is software processing performed by executing a program in the exemplary embodiment described above, the processing may be performed by hardware. Alternatively, the processing may be performed by a combination of both software and hardware. Moreover, a program stored in ROM may be distributed in a format stored on a non-transitory recording medium.

The present disclosure is not limited to the above description, and various other modifications may be implemented within a range not departing from the spirit of the present disclosure.

For example, the control section 512 of the CPU 51 may perform control so as to display a list of selection information for plural agents on the touch panel 14 in cases in which specific operation information has been received from the user. For example, a button used to call on an agent may be provided on a steering wheel of the vehicle, and the control section 512 may display a list of selection information for plural agents on the touch panel 14 in cases in which the user operates this button (for example by a long-press operation). Furthermore, reception of selection information selected by the user does not need to involve the touch panel 14, and may for example be received through such a button provided to the steering wheel.

An object of the present disclosure is to provide an agent control device, an agent control method, and a non-transitory recording medium capable of performing smooth agent selection during user selection of a utilizable agent when on board a vehicle.

### Solution to Problem

A first aspect of the disclosure is an agent control device that includes: a memory; and a processor coupled to the memory. The processor is configured to acquire identification information for a plurality of agents utilizable inside a vehicle, and perform control so as to display, on a display device, a list of selection information for the plurality of agents according to the acquired identification information for the plurality of agents, and activate an agent corresponding to selection information selected by a user inside the vehicle.

The agent control device acquires the identification information for the plural utilizable agents available inside the vehicle. Note that the agent of the present aspect performs speech interaction with the user, and executes processing that reflects the content of this interaction. The agent then uses equipment inside the vehicle to output an execution result of this processing so as to reflect the interaction content. The agent is implemented by a predetermined computer executing a program. The agent control device then performs control so as to display on the display device the list of selection information for the plural agents according to the acquired identification information for the plural agents, and performs control to activate an agent corresponding to the selection information selected by the user inside the vehicle. The agent control device of the first aspect is capable of performing smooth agent selection during user selection of a utilizable agent when on board the vehicle.

A second aspect of the disclosure is the agent control device of the first aspect, wherein the processor is configured to perform control to display, on the display device, the list of selection information for the plurality of agents, in a case in which specific operation information has been received. The agent control device of the second aspect responds to the specific operation information from user operation so as to display the list of selection information for the plural agents on the display device, thereby enabling smoother agent selection to be performed.

A third aspect of the disclosure is the agent control device of the first aspect, wherein the processor is configured to display the list of selection information for the plurality of agents on the display device, in a swipeable format. The agent control device of the third aspect enables an agent to be selected by a user swipe operation, thereby enabling smoother agent selection to be performed.

The first aspect to the third aspect may also be implemented by a method or a program recorded on a non-transitory recording medium.

### ADVANTAGEOUS EFFECTS OF INVENTION

The present disclosure described above exhibits the advantageous effect of enabling smooth agent selection to be performed during user selection of a utilizable agent when on board a vehicle.

What is claimed is:

1. An agent control device comprising:
a memory; and
a processor coupled to the memory, the processor being configured to:
acquire identification information for a plurality of agents utilizable inside a vehicle, and
perform control so as to display, on a display device, a list of selection information for the plurality of agents according to the acquired identification information for the plurality of agents, and activate an agent corresponding to selection information selected by a user inside the vehicle.

2. The agent control device of claim 1, wherein the processor is configured to perform control to display, on the display device, the list of selection information for the plurality of agents, in a case in which specific operation information has been received.

3. The agent control device of claim 1, wherein the processor is configured to display the list of selection information for the plurality of agents on the display device, in a swipeable format.

4. An agent control method, comprising:
by a processor,
acquiring identification information for a plurality of agents utilizable inside a vehicle; and
controlling a display device so as to display a list of selection information for the plurality of agents according to the acquired identification information for the plurality of agents, and activating an agent corresponding to selection information selected by a user.

5. The agent control method of claim 4, wherein control is performed to display, on the display device, the list of selection information for the plurality of agents, in a case in which specific operation information has been received.

6. The agent control method of claim 4, wherein the list of selection information for the plurality of agents is displayed on the display device in a swipeable format.

7. A non-transitory recording medium storing a program that is executable by a computer to perform processing, the processing comprising:
acquiring identification information for a plurality of agents utilizable inside a vehicle; and
controlling a display device so as to display a list of selection information for the plurality of agents according to the acquired identification information for the plurality of agents, and activating an agent corresponding to selection information selected by a user.

8. The non-transitory recording medium of claim 7, wherein control is performed to display, on the display device, the list of selection information for the plurality of agents, in a case in which specific operation information has been received.

9. The non-transitory recording medium of claim 7, wherein the list of selection information for the plurality of agents is displayed on the display device in a swipeable format.
